(19) United States
(12) Patent Application Publication
(10) Pub. No.: US 2008/0291204 A1
(43) Pub. Date: Nov. 27, 2008

(54) COUPLED PLACEMENT OF ITEMS USING STABLE MARRIAGE TECHNIQUES

(75) Inventors: Madhukar R. Korupolu, Sunnyvale, CA (US); Aameek Singh, Smyrna, GA (US)

Correspondence Address: CANADY & LORTZ LLP- IBM, 2540 HUNTINGTON DRIVE, SUITE 205, SAN MARINO, CA, 91108, US

(73) Assignee: International Business Machines Corporation, San Jose, CA (US)

(21) Appl. No.: 11/752,288

(22) Filed: May 22, 2007

(51) Int. Cl. G06T 11/20

(52) U.S. Cl. 345/440

(57) ABSTRACT

A program and method are disclosed for placing coupled items in a resource graph using stable marriage techniques. Each coupled item requires resources of a first resource and a second resource in a resource graph. The resource nodes in the graph provide either the first resource or the second resource or both. Coupled placement defines each item as having two elements, one representing the first resource requirement and the other representing the second resource requirement, which must be placed on a pair of connected resource nodes. The objective is to place the coupled item elements among nodes of the resource graph without exceeding the first resource capacities and second resource capacities at resource nodes while keeping the total cost over all items small. A stable marriage process guides the placement that may also employ knapsacking of multiple elements on resource nodes and a swapping analysis to further optimize placement.

### BACKGROUND OF THE INVENTION

1. Field of the Invention

This invention relates to analysis of resource graphs. Particularly, this invention relates to systems for placing coupled items in a resource graph using stable marriage techniques.

2. Description of the Related Art

Consider a set of items I=I₁, I₂, . . . I_{|n|} where each item Iᵢ requires resources (e.g., raw materials) of two kinds A and B in some quantity. For item Iᵢ, let A_{req}(Iᵢ) denote the amount of resource A it requires, and let B_{req}(lᵢ) denote the amount of resource B it requires. For example, A and B could be raw materials that go into manufacturing the item Iᵢ, or they could be the production (mining/farming) and processing (refining) resources needed for manufacturing item Iᵢ. In the computing domain they could be the CPU and storage resources required by an application.

Let G=(V, E) be an underlying graph that captures the availability of these resources A and B. Each node νεV has a certain limited supply or capacity Cap_{A}(ν) of A and a certain limited supply or capacity Cap_{B}(ν) of B. Some nodes ν are exclusive providers of resource A only (i.e. Cap_{A}(ν)>0 and Cap_{B}(ν)=0). Some nodes ν are exclusive providers of resource B only (i.e. Cap_{B}(ν)>0 and Cap_{A}(ν)=0) while some nodes are heterogeneous providing both A and B. The edges E capture the topology or connectivity among the nodes of the graph.

The goal is to place the A and B requirements of each item Iᵢ among the nodes in this graph, i.e. where each item would derive its resources from. Let Cost(Iᵢ, vⱼ , vₖ) denote the cost incurred by item Iᵢ if its A requirement was placed (allocated) on node vⱼ and its B requirement was placed (allocated) on node vₖ. For example, if vⱼ and vₖ are the same node or are close-by then this cost could be lower. Otherwise it could be higher. In general the cost can capture among other things the distance between nodes vⱼ and vₖ as well as the affinity of item Iᵢ for the nodes vⱼ and vₖ.

Given these costs, the objective is to place or allocate the A and B requirements of each item Iᵢ among the nodes of the graph G so as to minimize the overall cost.

$$min {\sum }_{i} Cost ( {I}_{i} , {I}_{i} . A , {I}_{i} . B )$$

while ensuring that the capacities at the nodes are not exceeded.

$$∀ j {\sum }_{i : {I}_{i} . A = {v}_{j}} {A}_{req} ( {I}_{i} ) \leq {Cap}_{A} ( {v}_{j} )$$

$$∀ k {\sum }_{k : {I}_{i} . B = {v}_{k}} {B}_{req} ( {I}_{i} ) \leq {Cap}_{B} ( {v}_{k} )$$

While this framework works for any general cost function, for ease of exposition and concreteness a special case of the cost function may be used where it is a measure of the rate of transfer required for the item between the two nodes and the distance between the two nodes. In other words,

Cost(Iᵢ,νⱼ,νₖ)=Rate(Iᵢ)*dist(νⱼ,νₖ),

where Rate(Iᵢ) is a measure of the rate of transfer required between the resources A and B for item Iᵢ. In manufacturing, for example, it may represent the quantity shipped per day from A to B. In computing, on the other hand, it may represent the number of bytes transferred per second from storage to CPU of the application. This cost function captures some of the desired features and complexities of the problem and is yet easy to describe. The framework, however, holds for any general cost function Cost(Iᵢ, vⱼ, vₖ) that the user chooses to use.

Such problems arise in many situations where two distinct item types need to be allocated to two resources and the cost of the allocation is determined by the choice of those resources. For example, for placing CPU and storage in a storage area network, depending upon where application storage is placed, all CPU nodes have a certain “affinity” to that storage node and performance of that application will depend on where the CPU is placed. Similar questions arise in deciding where to produce and where to process items in manufacturing. These questions also arise in grid computing and other domains where data and computational resources need to be placed in a coupled manner.

Most current solutions look at only placing one item in a set of resources—e.g. File Allocation Problem, Generalized Assignment Problem and many area specific approximation algorithms—e.g. storage placement, CPU load balancing etc.

This problem captures the basic questions inherent in placing two items in a coupled manner. The NP-Hard nature of the problem can be established by reducing to the 0/1 Knapsack problem. Even if a simpler case of this problem, involving two exclusive resource-A nodes (one is a catch-all node of infinite capacity and large cost) and fixed resource-B allocation, can be solved, it can be used to solve the knapsack problem. This can be solved by making the second resource-A node correspond to the knapsack and setting the costs and A_{req} requirements accordingly. Having to decide coupled placements for both A and B with general cost functions makes the problem more complex.

If either Resource-A or Resource-B allocations are fixed and only the other needs to be determined then there is related work in the computing domain for storage and CPU placement of applications in a data center: File Allocation Problem placing files/storage assuming CPU is fixed; Minerva, Hippodrome assume CPU locations are fixed while planning storage placement; Generalized Assignment problems: Assigning tasks to processors (CPUs)—they have been well-studied with several heuristics proposed but they do not consider the coupled allocation.

If the resource requirement (for A and B) for items can always be split across multiple resource nodes, then one could also model it as a multi-commodity flow problem—one commodity per item, introduce a source node for the resource-A requirement of each item and a sink node for resource-B requirement, with the source node connected to all nodes with nonzero A capacity, nonzero resource-B nodes connected to the sink node and appropriate costs on the resource-A and resource-B node pairs. However multi-commodity flow problems are known to be very hard to solve in practice even for medium sized instances. And if the splitting is not justifiable for items (e.g., it requires sequential processing at a single location), then we would need an unsplittable flow version for multi-commodity flows, which becomes even harder in practice.

Another important aspect of the problem is non-uniform costs. If the cost for each item Iᵢ were the same for all (vⱼ, vₖ) pairs then the problem could be simplified to placement for resource-A and B independently without coupling. An algorithm, INDV-GR, that follows this approach will be discussed. However, it suffers from many drawbacks.

U.S. Patent Application Publication No.2002/0156667 A1 by Bergstrom, published on Oct. 24, 2002, discloses a method of determining allocations in a business operation to maximize profit includes: collecting profit data for a plurality of classes in the business operation, where each class includes an allocation having a cost function and each allocation belongs to the group consisting of physical allocations and economic allocations; determining profit functions for the allocations from the profit data; formulating a Multiple Choice Knapsack Problem to maximize profit from the profit functions, the cost functions, and a cost constraint; and solving the Multiple Choice Knapsack Problem to determine values for the allocations.

U.S. Patent Application Publication No. 2002/0046316 A1 by Borowsky et al., published on Apr. 18, 2002, discloses an apparatus for and a method of non-linear constraint optimization in a storage system configuration. In accordance with the primary aspect of the present invention, the objective function for a storage system is determined, the workload units are selected and their standards are determined, and the storage devices are selected and their characteristics are determined. These selections and determinations are then used by a constraint based solver through non-linear constraint integer optimization to generate an assignment plan for the workload units to the storage devices.

Existing systems and methods of resource graph analysis do not address the problem of placing coupled items on nodes of resource graphs. Thus, there is a need in the art for systems and methods of resource graph analysis to minimize costs when placing coupled items in resource graphs. Further, there is a need for such systems and methods to add maximize value of the coupled item placement in the resource graphs. There is also a need for such systems and methods to consider alternate placement combinations of the coupled item elements to minimize costs. These and other needs are met by the present invention as detailed hereafter.

### SUMMARY OF THE INVENTION

A program and method are disclosed for placing coupled items in a resource graph using stable marriage techniques. Each coupled item requires resources of a first resource and a second resource in a resource graph. The resource nodes in the graph provide either the first resource or the second resource or both. Coupled placement defines each item as having two elements, one representing the first resource requirement and the other representing the second resource requirement, which must be placed on a pair of connected resource nodes. The objective is to place the coupled item elements among nodes of the resource graph without exceeding the first resource capacities and second resource capacities at resource nodes while keeping the total cost over all items small. A stable marriage process guides the placement that may also employ knapsacking of multiple elements on resource nodes and a swapping analysis to further optimize placement.

A typical embodiment of the invention comprises a computer program embodied on a computer readable medium, including program instructions for ranking a first resource node group for each first element of a plurality of coupled items, each of the plurality of coupled items having a first element and a second element, program instructions for determining placement of each first element of the plurality of coupled items on one first resource node of the first resource node group by iteratively comparing in order of ranking a first profit value associated with each placement and placing the first element having a highest first profit value, program instructions for ranking a second resource node group for each second element of the plurality of coupled items, and program instructions for determining placement of each second element of the plurality of coupled items on one second resource node of the second resource node group by iteratively comparing in order of ranking a second profit value associated with each placement and placing the second element having a highest second profit value. Each of the first element and the second element are to be placed on a connected pair of first and second resource nodes and the first profit value and the second profit value are based on a relationship between the connected pair of first and second resource nodes. Ranking the resource node groups is similar to forming preference lists in the terminology of the stable marriage problem. Likewise, determining placements through an iterative comparison of cost values corresponds to the repeated proposals and evaluations resulting in either acceptance or rejection in the context of the stable marriage problem.

In further embodiments, program instructions may be used for knapsack placement of more than one first element of the plurality of coupled items on at least one first resource node of the first resource node group. In addition, program instructions for swapping placement of a pair of coupled items of the plurality of coupled items and keeping the change only if a lower cost to the resource graph results may also be used. In addition, each knapsack placement may comprise maximizing a profit value while staying under a specified overall size and the profit value may be determined by a cost difference between two different coupled item placements.

In some embodiments, the first profit value may be determined from a first cost function and the second profit value may be determined from a second cost function and the first cost function and the second cost function are each based on a distance value between the connected pair of first and second resource nodes.

Also, each iteration may comprise placement for every first element of each of the plurality of coupled items, followed by placement for every second element of each of the plurality of coupled items. Each iteration may further include a swap process comprising swapping the placement of a pair of coupled items of the plurality of coupled items, and keeping the change only if a lower cost to the resource graph results or else returning the pair of coupled items to the placement before the swap. The swap process may be performed following placement for every second element of each of the plurality of coupled items. The iteration may be repeated until a chosen termination criterion is met.

Similarly, a typical method embodiment of the invention, comprises the steps of ranking a first resource node group for each first element of a plurality of coupled items, each of the plurality of coupled items having a first element and a second element, determining placement of each first element of the plurality of coupled items on one first resource node of the first resource node group by iteratively comparing a first cost value associated with each placement and placing the first element having a lowest first cost value, ranking a second resource node group for each second element of the plurality of coupled items, and determining placement of each second element of the plurality of coupled items on one second resource node of the second resource node group by iteratively comparing a second cost value associated with each placement and placing the second element having a lowest second cost value. Likewise here, each of the first element and the second element are to be placed on a connected pair of first and second resource nodes and the first cost value and the second cost value are based on a relationship between the connected pair of first and second resource nodes. Method embodiments of the invention may be further modified consistent with system and/or program embodiments of the invention described herein.

### BRIEF DESCRIPTION OF THE DRAWINGS

Referring now to the drawings in which like reference numbers represent corresponding parts throughout:

FIG. 1A illustrates a typical resource graph, consisting of nodes and connections between them;

FIG. 1B illustrates a typical resource graph, consisting of nodes, connections, and single items placed on the nodes;

FIG. 1C illustrates a typical resource graph, consisting of nodes, connections, and coupled items placed on the nodes;

FIG. 2 illustrates an exemplary hardware environment for implementing an embodiment of the invention;

FIG. 3A illustrates an exemplary resource graph before the first step of the SPARK resource placement algorithm;

FIG. 3B illustrates an exemplary resource graph after the first step of the SPARK resource placement algorithm, resulting in a rearrangement for Item-2;

FIG. 3C illustrates an exemplary resource graph after the step of the SPARK resource placement algorithm, resulting in another rearrangement for Item-2;

FIG. 4A illustrates an exemplary resource graph before the initialization of the SPARK-Swap step of the algorithm;

FIG. 4B illustrates an exemplary resource graph after the completion of the SPARK-Swap step of the algorithm;

FIG. 5 is a flowchart of exemplary steps of couple placement of items in graphs using stable marriage techniques;

FIG. 6 is a flowchart of exemplary steps of performing the SPARK resource placement algorithm on a particular resource;

FIG. 7 is a flowchart of exemplary steps of performing the SPARK-Swap algorithm on a given resource graph; and

FIGS. 8A to 8C compare performance of an example SPARK algorithm with other algorithms.

### DETAILED DESCRIPTION OF THE PREFERRED EMBODIMENT

1. Overview

Embodiments of the invention apply an approach based on each coupled item to be placed in a resource graph making a preference list of resource nodes for a first resource, and proposing to the first resource node in its preference list. The resource nodes upon receiving the proposals compute a profit value for each proposal using a conservative estimation and then may perform a knapsack computation to accept the subset of proposals that yield the most value while keeping their total size below the node's resource capacity. The rejected items move to the next node in their preference list and propose to them and the process repeats until they all get selected at some node. This constitutes one round for the first resource. One such round for the first resource, one such round for the second resource, and a swap step to exchange coupled item element pairs comprise one iteration of the algorithm. One or more iterations are repeated until a preset termination condition is achieved.

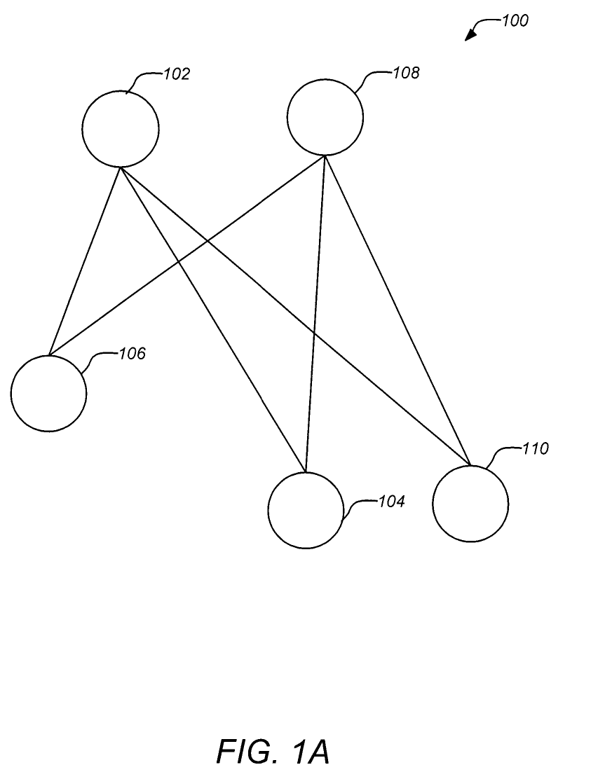

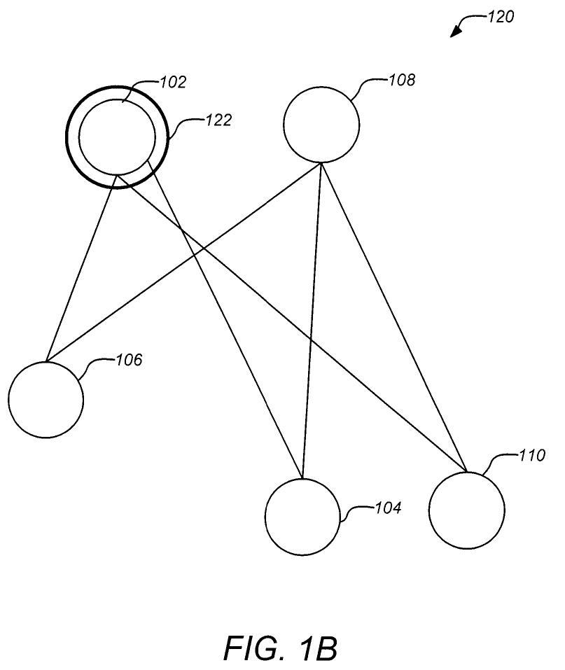

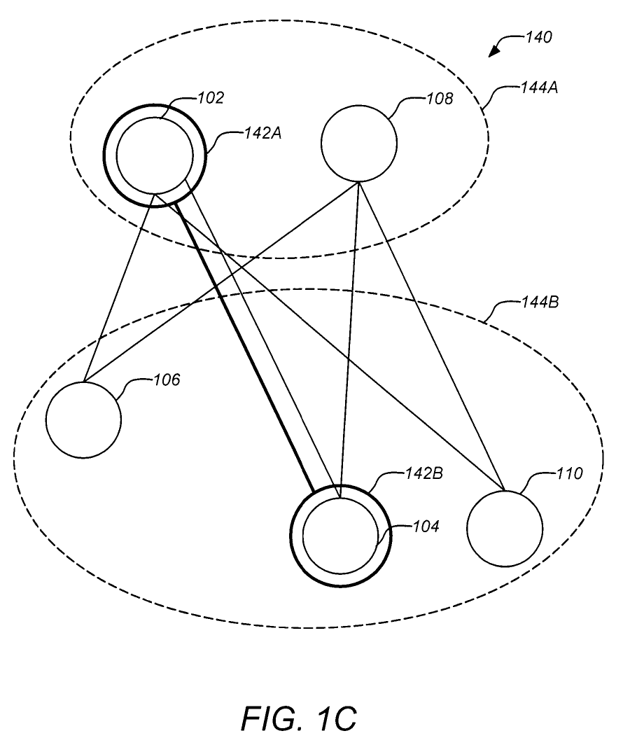

FIG. 1A illustrates an exemplary resource graph 100. Within the graph 100, there exist resource nodes 102-110 and connections between them. Each resource node 102-110 represents a resource (which may include one or more resource types) and the lines represent the connections of the resource nodes. For example, assume a first resource node 102 can supply a first resource (A) and a second resource (B). Also, assume a second node 104 can supply a different amount of both the first resource and the second resource. If an item is placed on either resource node 102, 104, then the item will be able to utilize any resources of that particular resource node.

FIG. 1B illustrates an exemplary resource graph 120, but now with an item 122 placed on a resource node 102. Since the item 122 is now on the resource node 102, it may use any amount of the first and second resources it needs that the resource node 102 can provide. This form of item placement (i.e., one item to one resource node) is known in the art.

FIG. 1C illustrates an exemplary resource graph 140, but now with a coupled item (represented as two related elements 142A & 142B) placed on nodes connected 102 & 104, one element 142A & 142B placed on each node. Since the coupled item 142A & 142B is now on the pair of nodes 102 & 104, each element 142A & 142B may use the resources of that particular node 102 & 104, respectively. It is important to understand that a coupled item is restricted to placement on two nodes that are connected to each other. In this example, it is also desirable to organize the resource nodes into a first resource node group 144A and a second resource node group 144B such that connections are only made between nodes of the different groups and not nodes within a group. In addition, better or worse placements of coupled nodes are determined in part by the particular combination and relationship between resource nodes that are selected for each element of the coupled item. For example, the distance of the connections between any two resource nodes may be a factor in evaluating placement of the coupled items. Embodiments of the invention are directed to systems and methods for determining the optimized placement of coupled items in a resource graph.

2. Hardware Environment

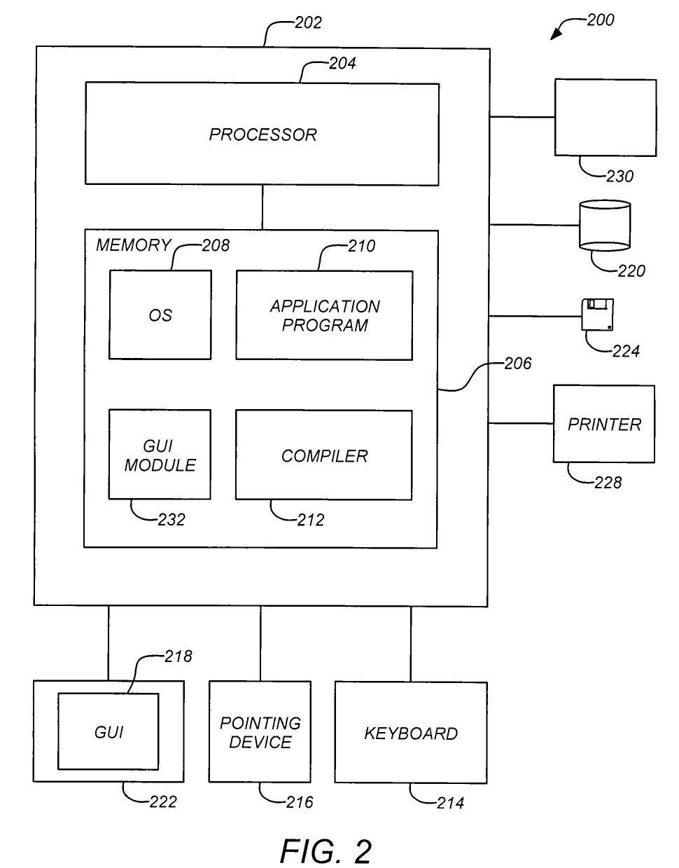

FIG. 2 illustrates an exemplary computer system 200 that can be used to implement embodiments of the present invention. The computer 202 comprises a processor 204 and a memory 206, such as random access memory (RAM). The computer 202 is operatively coupled to a display 222, which presents images such as windows to the user on a graphical user interface 218. The computer 202 may be coupled to other devices, such as a keyboard 214, a mouse device 216, a printer 228, etc. Of course, those skilled in the art will recognize that any combination of the above components, or any number of different components, peripherals, and other devices, may be used with the computer 202.

Generally, the computer 202 operates under control of an operating system 208 (e.g. z/OS, OS/2, LINUX, UNIX, WINDOWS, MAC OS) stored in the memory 206, and interfaces with the user to accept inputs and commands and to present results, for example through a graphical user interface (GUI) module 232. Although the GUI module 232 is depicted as a separate module, the instructions performing the GUI functions can be resident or distributed in the operating system 208, a computer program 210, or implemented with special purpose memory and processors.

The computer 202 also implements a compiler 212 which allows one or more application programs 210 written in a programming language such as COBOL, PL/1, C, C++, JAVA, ADA, BASIC, VISUAL BASIC or any other programming language to be translated into code that is readable by the processor 204. After completion, the computer program 210 accesses and manipulates data stored in the memory 206 of the computer 202 using the relationships and logic generated using the compiler 212. The computer 202 also optionally comprises an external data communication device 230 such as a modem, satellite link, ethernet card, wireless link or other device for communicating with other computers, e.g. via the Internet or other network.

Instructions implementing the operating system 208, the computer program 210, and the compiler 212 may be tangibly embodied in a computer-readable medium, e.g., data storage device 220, which may include one or more fixed or removable data storage devices, such as a zip drive, floppy disc 224, hard drive, DVD/CD-ROM, digital tape, etc., which are generically represented as the floppy disc 224. Further, the operating system 208 and the computer program 210 comprise instructions which, when read and executed by the computer 202, cause the computer 202 to perform the steps necessary to implement and/or use the present invention. Computer program 210 and/or operating system 208 instructions may also be tangibly embodied in the memory 206 and/or transmitted through or accessed by the data communication device 230. As such, the terms “article of manufacture,” “program storage device” and “computer program product” as may be used herein are intended to encompass a computer program accessible and/or operable from any computer readable device or media.

Embodiments of the present invention are generally directed to a software application program 210 for performing an analysis of resource graphs including placing coupled items in a resource graph using stable marriage techniques as described herein. An example implementation is described further in section 10 hereafter. Specific resource graphs can be developed to solve resource distribution problems for a wide range of domains, e.g. production (mining/farming) and processing (refining) resources needed for manufacturing an item or CPU and storage resources required for computing. Embodiments of the invention are directed to a general computerized tool for analyzing resource distribution in any domain. The program 210 may operate within a single computer 202 or as part of a distributed computer system comprising a network of computing and storage devices. The network may encompass one or more computer/storage devices connected via a local area network and/or Internet connection (which may be public or secure, e.g., through a VPN connection).

Those skilled in the art will recognize many modifications may be made to this hardware environment without departing from the scope of the present invention. For example, those skilled in the art will recognize that any combination of the above components, or any number of different components, peripherals, and other devices, may be used with the present invention meeting the functional requirements to support and implement various embodiments of the invention described herein.

3. Greedy Individual Placement Algorithm

This section outlines one of two simpler algorithms foundational to embodiments of the invention. The greedy individual placement algorithm INDV-GR places resource-A and resource-B of items independently in a naturally greedy fashion. For ease in exposition, the following example cost function may be used.

Cost(Iᵢ,νⱼ,νₖ)=Rate(Iᵢ)*dist(νⱼ,νₖ)

Example pseudocode for the greedy individual placement algorithm is given as Alg-1 hereafter.

The INDV-GR algorithm (Alg-1) first places items' resource-A by sorting items by Rate/A_{req} and greedily assigning them to nodes sorted by LeastCost, which is the cost from the closest resource-B node. Intuitively, INDV-GR tries to automatically place highest rate items (normalized by their resource-A requirements) on resource-A nodes that have the closest resource-B nodes. In the next phase, it will similarly place items' resource-B on resource-B nodes (that is, nodes that have non-zero resource-B availability).

However, as a consequence of its greedy nature, a poor placement of items can result. For example, it can place an item with 600 units A requirement, 1200 units rate at a preferred A node with capacity 800 units instead of choosing two items with 500 and 300 units A requirement and 900, 500 units rate (cumulative rate of 1400). Also, INDV-GR does not account for A-node and B-node affinities beyond using a rough LeastCost metric. For example, if Iᵢ resource-A is placed on vⱼ, INDV-GR does not especially try to place Iᵢ resource-B on the node closest to vⱼ.

The example pseudocode for Algorithm-1, the greedy individual algorithm, is presented here.

| | |
|---|---|
| 1: | RankedItemsAQ ← Apps sorted by Rate/A_{req} // decreasing |
| 2: | RankedAQ ← Resource-A node sorted by LeastCost // increasing |
| 3: | while RankedItemsAQ ≠ Ø do |
| 4: | Item ← RankedItemsAQ.pop( ) |
| 5: | for (i=0; i<RankedAQ.size; i++) do |
| 6: | Aⱼ ← RankedAQ[i] |
| 7: | if (A_{req}(Iᵢ) ≦ Aⱼ.Available) then |
| 8: | Place Iᵢ resource-A on Aⱼ |
| 9: | break |
| 10: | end if |
| 11: | end for |
| 12: | if (Iᵢ not placed) then |
| 13: | Error: No placement found |
| 14: | end if |
| 15: | end while |
| 16: | Similar for resource-B placement |

4. Greedy Pairs Placement Algorithm

The poor placement of items can potentially be improved by a greedy pairs placement algorithm PAIR-GR that considers items in a greedy fashion and places each ones A and B pair simultaneously.

The PAIR-GR algorithm (Alg-2) attempts such a placement. It tries to place items sorted by Rate/(A_{req}*B_{req}) on resource-A, resource-B node pairs sorted by the cost between the nodes of the pair. With this, items are placed simultaneously into A and B buckets based on their affinity measured by the cost metric.

Notice that PAIR-GR also suffers from the shortcomings of the greedy placement where an early sub-optimum decision results in poor placement. Ideally, each resource-A (and resource-B) node should be able to select item combinations that best minimize the overall cost value of the system. This hints at usage of Knapsack-like algorithms. In addition, an important missing component of these greedy algorithms is that, while items have a certain preference order of resource nodes that they would like to be placed on (based on the cost function), the resource nodes would have a different preference determined by their capacity and which item combinations fit the best. Matching these two distinct preference orders indicates a connection to the Stable-Marriage problem described hereafter.

Notice that placing an item together on resource-A, resource-B node pair (Aⱼ,Bₖ) (as done by PAIR-GR) would impact resource availability in all overlapping pairs (Aⱼ,Bₗ) and (Aₘ,Bₖ). This overlap can have cascading consequences. This indicates that perhaps placing resource-A and resource-B separately, yet coupled through affinities would hold the key to solving this problem. Combining this observation with knapsacks and the stable proposal algorithm leads us to SPARK.

The example pseudocode for alg-2, the greedy pairs algorithm, is presented here.

| | |
|---|---|
| 1: | RankedItemsQ ← Items sorted by Rate/(A_{req}+B_{req}) |
| 2: | RankedPairsQ ← {A-nodes × B-nodes} sorted by cost |
| 3: | while RankedItemsQ ≠ Ø do |
| 4: | Iᵢ ← RankedItemsQ.pop( ) |
| 5: | for (i=0; i<RankedPairsQ.size; i++) do |
| 6: | Aⱼ ← RankedPairsQ[i].A( ) |
| 7: | Bₖ ← RankedPairsQ[i].B( ) |
| 8: | if (Iᵢ.A_{req} ≦ Aⱼ.Avl AND Iᵢ.Breq ≦ Bk.Avl) then |
| 9: | Place Iᵢ resource-A on Aⱼ, Iᵢ resource-B on Bₖ |
| 10: | break |
| 11: | end if |
| 12: | end for |
| 13: | if (Iᵢ not placed) then |
| 14: | Error: No placement found |
| 15: | end if |
| 16: | end while |

5. The Stable Marriage Problem

The stable marriage problem may be illustrated in the following manner. Given n men and n women, where each person has a ranked preference list of the members of the opposite group, pair the men and women such that there are no two people of opposite group who would both rather have each other than their current partners. If there are no such people, then the marriages are said to be “stable”. Note that this is similar to the residency-matching problem for medical graduate applicants where each applicant submits his ranked list of preferred medical universities and each university submits its ranked list of preferred applicants. Many analogous scenarios in different domains may be devised.

The known Gale-Shapely Proposal algorithm is the one that is commonly used to resolve such problems. It involves a number of “rounds” (or iterations) where each man who is not yet engaged “proposes” to the next most-preferred woman in his ordered list. She then compares the proposal with the best one she has so far and accepts it if it is higher than her current one and rejects otherwise. The man who is rejected becomes unengaged and moves to the next in his preference list. This iterative process is proved to yield stable results.

Only women may switch partners to increase their happiness, as the man is the one proposing in all of the cases. If a man is abandoned by a woman, he is now unengaged, and must repeat the process. This process is performed until each man is paired with a woman, and all of the marriages are stable. This setting of men proposing to women is referred to as male-optimal, and can switch to female optimal if the roles are reversed.

To provide an example of the stable marriage problem, suppose there are two sets, each with three elements each. Each element has provided its order of preference. Elements A, B and C comprise Set I and elements D, E and F comprise Set II.
A's order of preference is D, F, E.
B's order of preference is E, D, F.
C's order of preference is D, E, F.
D's order of preference is C, A, B.
E's order of preference is B, C, A.
F's order of preference is A, C, B.

In the first step, A proposes to D, since it is the first on A's list. Since D is unmatched, D accepts, and A and D are paired. Next, B proposes to E, since it is the first on E's list. Since E is unmatched, E accepts, and B and E are paired. Next, C proposes to D, since it is the first on C's list, even though D is currently engaged. D prefers C to A, so it leaves A, and now C and D are paired. A must look again because it is now unmatched. A proposes to F, since it is the next on A's list that A has not proposed to yet. Since, F is unmatched, F accepts, and A and F are paired. Since there are no more unmatched members of Set I, the algorithm is complete, and all of the matches are stable.

6. Knapsack Problem

The knapsack problem may now be illustrated in the following manner. Given n items, aₗ, through aₙ, each item as has size sⱼ and a profit value vⱼ. The total size of the knapsack is S. The 0/1 knapsack problem asks for the collection of items to place in the knapsack so as to maximize the profit. This particular knapsack problem is known as the 0/1 knapsack problem because each item is either selected or not selected. There are other knapsack problems that exist. Mathematically the 0/1 knapsack problem can be expressed as:

$$max {\sum }_{j = 1}^{n} {v}_{j} {x}_{j} subject to {\sum }_{j = 1}^{n} {s}_{j} {x}_{j} \leq S$$

where xⱼ=0 or 1 indicating whether item aⱼ is selected or not. This problem is known to be NP-Hard and has been well-studied for heuristics of near optimal practical solutions.

For example, assume there is a knapsack that can carry only 100 square inches of items. The items to choose from are: item A, which is worth 60 dollars and is 50 square inches; item B, which is with 80 dollars and is 45 square inches; item C, which is worth 30 dollars and is 30 square inches; item D, which is worth 5 dollars and is 20 square inches; item E, which is worth 35 dollars and is 10 square inches; and item F, which is worth 10 dollars and is 5 square inches.

Obviously, the optimal configuration is to pick items B, C, E and F, even though this does not fill our knapsack completely, it maximizes the value under some fixed cost. The solution for simple knapsack problems such as this may be performed by inspection in a short amount of time, but more complex knapsack problems may be solved using dynamic programming.

7. Coupled Placement Algorithm: Stable Proposals and Resource Knapsacks

Consider a general scenario where say the resource-B part of items has been placed and we have to find appropriate locations for resource-A. Each item Iᵢ first constructs an ordered preference list of resource-A nodes as follows: Let Bₖ be the resource-B node where Iᵢ's resource-B is currently placed. Then all Aⱼ, 1≦j ≦A are ranked in increasing order of Cost(Iᵢ,Aⱼ,Bₖ). Once the preference lists are computed, each item begins by proposing to the first resource-A node on its list (like in the stable-marriage scenario). On the receiving end, each resource-A node looks at all the proposals it received. It computes a profit value for each such proposal that measures the utility of that proposal. How to compute these profit values is discussed later. We pick the node that received the highest cumulative profit value in proposals and do a knapsack computation for that node. This computation decides the set of items to choose so as to maximize the total value without violating the capacity constraints at the resource-A node. These chosen items are considered accepted at that node. The other ones are rejected. The rejected ones move down their list and propose to the next candidate. This process repeats until all items are accepted. The example pseudocode for this part is given in Alg-3.

A dummy resource-A node A_{dummy} (and similarly a dummy resource-B node B_{dummy}) of unlimited capacity and large costs from other nodes is defined. These would appear at the end of each preference list ensuring that the item would be accepted somewhere in the algorithm. This catch-all node provides a graceful termination mechanism for the algorithm.

Given these resource-A placements, the algorithm then determines the resource-B placements for items based on the affinities from the chosen resource-A locations. The pseudocode for the resource-B part is similar to the one in Alg-3.

The example pseudocode for Alg-3, the resource placement algorithm in Stable Proposals and Resource Knapsacks (SPARK), is presented here.

| | |
|---|---|
| 1: | for all Iᵢ in ItemsQ do |
| 2: | Create resource-A preference list sorted by distance from current |
| | Item resource-B placement |
| 3: | Propose to best resource-A node |
| 4: | end for |
| 5: | while (All items not placed) do |
| 6: | MaxA ← AQ[0] |
| 7: | for all Aⱼ in ItemsQ do |
| 8: | Compute proposals profit |
| 9: | MaxA ← max(MaxA.profit , Aⱼ.profit) |
| 10: | end for |
| 11: | Knapsack MaxA |
| 12: | for all Accepted items do |
| 13: | Place item resource-A on MaxA |
| 14: | end for |
| 15: | for all Rejected items do |
| 16: | Propose to next resource-A node in preference list |
| 17: | end for |
| 18: | end while |

8. Computing Profit Values

One of the key steps in the SPARK algorithm is how to compute the profit values for the proposals. Recall that when a resource-A node Aⱼ receives a proposal from an item Iᵢ it first determines a profit value for that proposal which it then uses in the knapsack step to determine which ones to accept.

Two cases can be distinguished here based on whether Iᵢ currently has a resource-A location or not (for example, if it got kicked out of its location, or it has not found a location yet). If it does, say at node Aⱼ′ (Aⱼ′ must be below Aⱼ in Iᵢ's preference list, otherwise Iᵢ would not have proposed to Aⱼ). Then the receiving node Aⱼ would look at how much the system would save in cost if it were to accept Iᵢ. This is essentially Cost(Iᵢ,Aⱼ′,Bₖ)−Cost(Iᵢ,Aⱼ,Bₖ) where Bₖ is the current (fixed for this resource-A placement round) location of Iᵢ's resource-A. This is taken as the profit value for Iᵢ's proposal to Aⱼ.

On the other hand, if Iᵢ does not have any resource-A location or if Iᵢ has storage at Aⱼ itself, then the receiving node Aⱼ would like to see how much more the system would lose if it did not select Iᵢ. If it knew which resource-A node Aⱼ′, Iᵢ would end up if not selected, then the computation is obvious. Just taking a difference as above from Aⱼ′ would give the necessary profit value. However where in its preference list Iᵢ would end up if Aⱼ rejects it, is not known at this time.

In the absence of this knowledge, a conservative approach is to assume that if Aⱼ rejects Iᵢ, then Iᵢ would go all the way to the dummy node for its resource-A. So with this, the profit value can be set to Cost(Iᵢ,A_{dummy},Bₖ)−Cost(Iᵢ,Aⱼ,Bₖ).

An aggressive approach is to assume that Iᵢ would get selected at the very next resource-A node in its preference list after Aⱼ. In this approach, the profit value would then become Cost(Iᵢ,Aⱼ′,Bₖ)−Cost(Iᵢ,Aⱼ,Bₖ) where Aⱼ′ is the node immediately after Aⱼ in the preference list for Iᵢ. The reason this is aggressive is that Aⱼ′ may not take Iᵢ either because it has low capacity or it has much better candidates to pick.

Though the combination of SPARK-A and SPARK-B address many possibilities well, they are not equipped to deal with certain scenarios where a move of either A or B of an item during a round of placement (either resource-A or resource-B) doesn't improve the placement, but moving both simultaneously does. This is where the SPARK-Swap step comes in. It takes two items Ii and Ii′ and exchanges their resource-A and resource-B locations if that improves the cost while still being within the capacity limits.

Combining these insights, the SPARK algorithm is summarized in Alg-4. It proceeds iteratively in rounds. In each round it does a proposal-and-knapsack scheme for resource-A, a similar one for resource-B, followed by a Swap step. It thus improves the solution iteratively, until a chosen termination criterion is met or until a local optimum is reached.

The pseudocode for Alg-4, the overall algorithm in SPARK, is presented here.

| | |
|---|---|
| 1: | MinCost ← ∞, SolutionCfg ← Ø |
| 2: | loop |
| 3: | SPARK-A( ) |
| 4: | SPARK-B( ) |
| 5: | SPARK-Swap( ) |
| 6: | Cost ← 0 |
| 7: | for all Iᵢ in ItemsQ do |
| 8: | Cost ← Cost + Cost(Iᵢ,Iᵢ.A,Iᵢ.B) |
| 9: | end for |
| 10: | if (Cost < MinCost) then |
| 11: | MinCost ← Cost |
| 12: | SolutionCfg ← current placement solution |
| 13: | else |
| 14: | break // termination by local optimum |
| 15: | end if |
| 16: | end loop |
| 17: | return SolutionCfg |

9. Example of Stable Proposals and Resource Knapsacks Algorithm

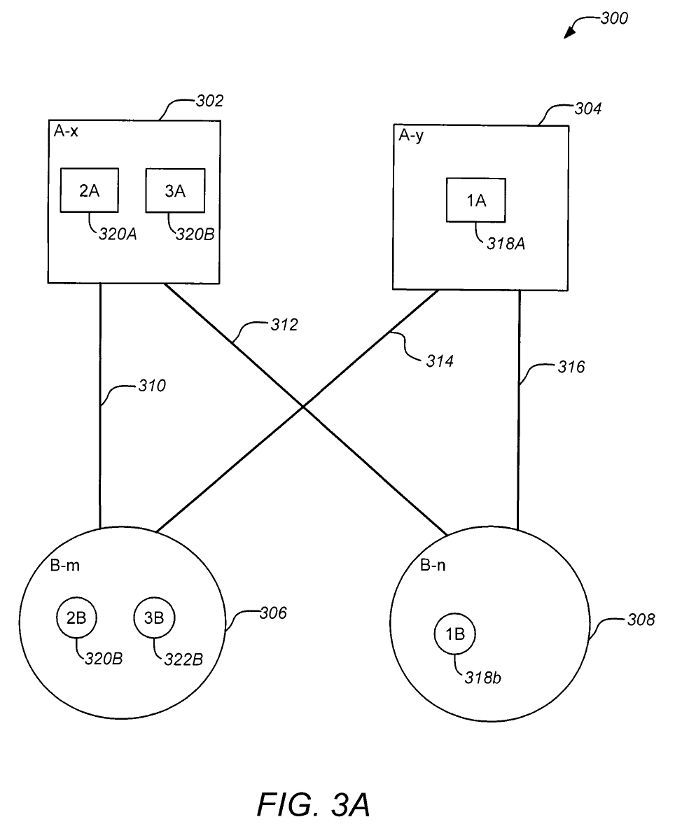

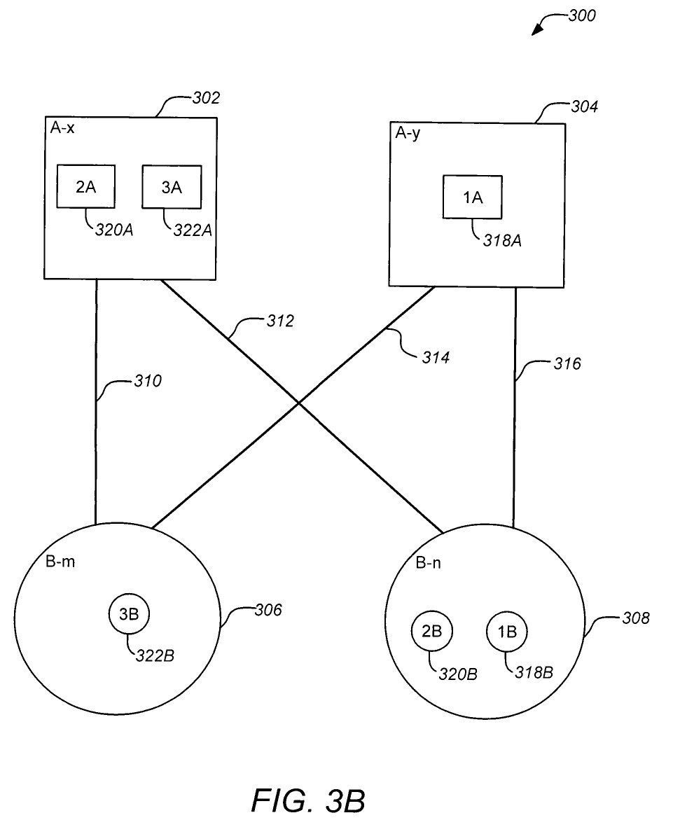

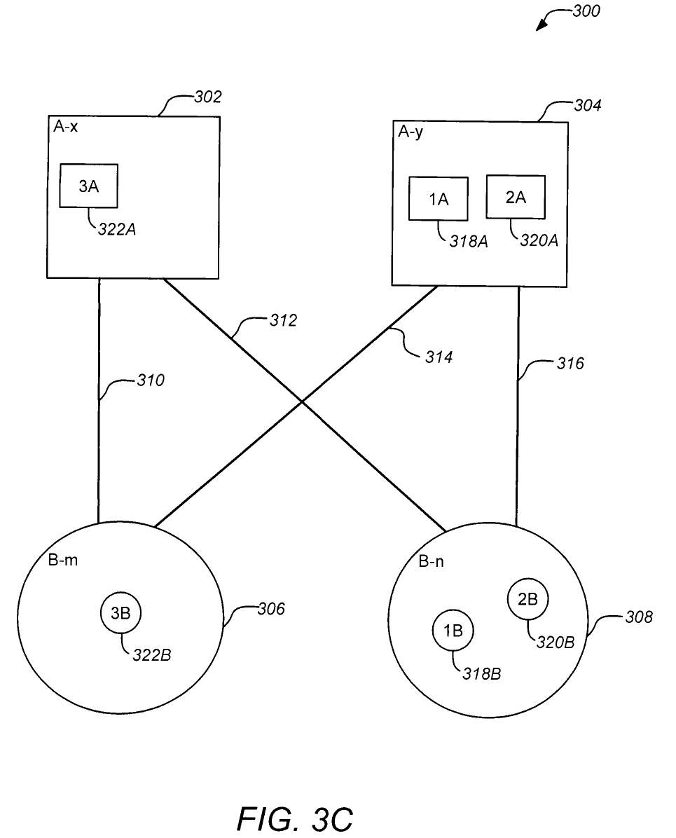

FIG. 3A illustrates a resource graph 300 before the execution of the algorithm. The node labeled A-x 302 is a node in the resource graph supplying 50 units of resource A. Node A-y 304 is a node in the resource graph supplying 50 units of resource A. Node B-m is a node in the resource graph supplying 80 units of resource B and node B-n is a node in the resource graph supplying 80 units of resource B. The two shapes of the nodes reflect the two different resources being supplied by the node.

The edges 310-316 illustrate the distance between the two nodes. The edge connecting A-x to B-m 310 has a distance of 4. The edge connecting A-x to B-n 312 has a distance of 3. The edge connecting A-y to B-m 314 has a distance of 4. The edge connecting A-y to B-n 316 has a distance of 2. These distance values will play a critical role in cost determination. As before, the example cost function is:

Cost(Iᵢ,νⱼ,νₖ)=Rate(Iᵢ)*dist(νⱼ,νₖ)

Currently, Item-1 (I1), 318A & 318B is placed on nodes A-y 304 and B-n 308. Again, the item is placed on two nodes because it is a coupled item. Item-2 (12), 320 A&B is placed on nodes A-x 302 and B-m 306. Item-3 (I3), 322 A&B is placed on A-x 302 and B-m 306.
For I1, the Rate=80, A_{req}=35, and B_{req}=50.
For I2, the Rate=10, A_{req}=15, and B_{req}=20.
For I3, the Rate=10, A_{req}=25, and B_{req}=60.

FIG. 3B illustrates the resource graph 330 after resource-B placement. I2.B, 320B, which used to be on node B-m 306, is now on node B-n 308. During resource-B placement, a preference list was created for each item, according to the cost function. Each item preferred B-n 308 to B-m 306. Since all of the items preferred node B-n 308, they all proposed to that node. The profit values for each item are then calculated, and since node B-n 308 was the only node that received any proposals, a knapsack computation will be done for the node B-n 308. The profit value for I1.B, 318B was 160, the profit value for I2.B, 320B was 10, and the profit value for I3.B, 322B was 10. B-n 308 has a maximum capacity of 80 units of resource B. Since I1.B, 318B had the highest value, it is chosen first. This leaves 30 units of resource B left between 12.B, 320B and I3.B, 322B. I3.B, 322B has a requirement exceeding the available resources, so I2.B, 320B is chosen, and reflected in the graph 330.

FIG. 3C illustrates the resource graph 340 after resource-A placement. I2.A 320A moved from node A-x 302 to node A-y 304. During resource-A placement, a preference list was created for each item, according to the cost function. Each item preferred A-y 304 to A-x 302. Since all of the items preferred node A-y 304, they all proposed to that node. The profit values for each item are then calculated, and since node A-y 304 was the only node that received any proposals, a knapsack computation will be done for the node A-y 304. The profit value for I1.A, 318A was 80, the profit value for Item-2A, 320A was 10, and the profit value for I3.A, 322A was 0. A-y 304 has a maximum capacity of 50 units of resource A. Since I1.A, 318A had the highest value, it is chosen first. This leaves 15 units of resource left. I2.A 320A is chosen because it requires 15 units of resource A and it has a higher profit value than I3.A 322A. In addition, I3.A 322A requires more units of resource A than is available. I2.A is chosen, and reflected in the graph 340.

The items, for example, could be applications in a data center and the resources could be CPU and storage that they need. SPARK-B brings I2.B 320B closer to I2.A and SPARK-A further improves by bringing I2.A closer to I2.B. Knapsacks help choose the I1+I2 combination over I3 during placement.

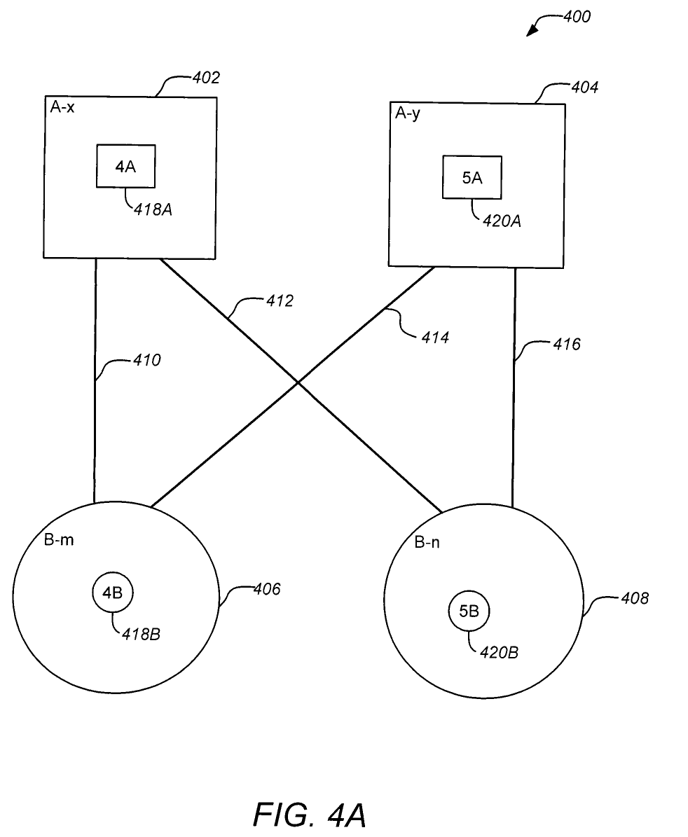

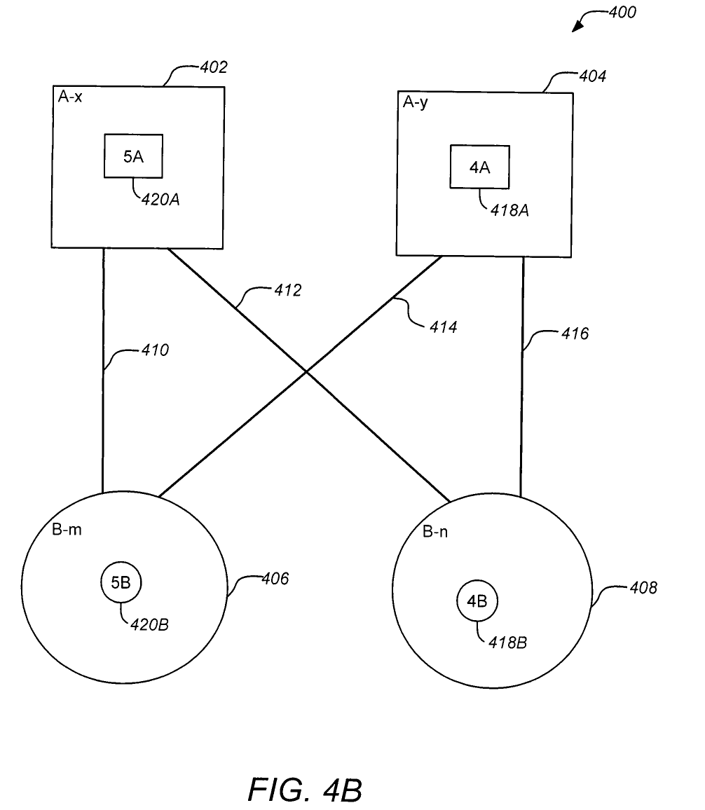

FIG. 4A illustrates a resource graph 400 where the SPARK-Swap is used to improve the cost. Nodes A-x 402 and A-y 404 both supply resource A. Nodes B-m 406 and B-n 408 supply resource B. Currently, Item-4 (I4), 418A & 418B is placed on nodes A-x 402 and B-m 406, and Item-5 (I5), 420A & 420B is placed on nodes A-y 404 and B-n408.

The edge connecting A-x to B-m 410 has a distance of 4. The edge connecting A-x to B-n 412 has a distance of 4. The edge connecting A-y to B-m 414 has a distance of 4. The edge connecting A-y to B-n 416 has a distance of 2.
For I4, the Rate=80, A_{req}=50, and B_{req}=70.
For I5, the Rate=10, A_{req}=50, and B_{req}=70.

Individual rounds cannot make the moves that result in a swap. During resource B placement, nodes B-m 406 and B-n 408 are equally preferable for I4, as they have the same distance from I4.A 418A. This is also the case when resource A placement is run. Using the cost function, it can be calculated that currently there is an overall cost of 340. I4, 418A & 418B contributes 320 to the overall cost and I5, 420A & 420B contributes 20 to the overall cost.

FIG. 4B illustrates a resource graph 430 after SPARK-Swap has been executed. I4 418A & 418B is now placed on nodes A-y 404 and B-n 408. I5 420A & 420B is now placed on nodes A-x 402 and B-m 406. Using the cost function, it can be calculated that the new overall cost is now 200, which is lower than that of the previous resource graph 400. I4, 418A & 418B now contributes only 160 to the overall cost and I5, 420A & 420B contributes 40 to the overall cost.

10. Exemplary Implementation of Stable Proposals and Resource Knapsacks

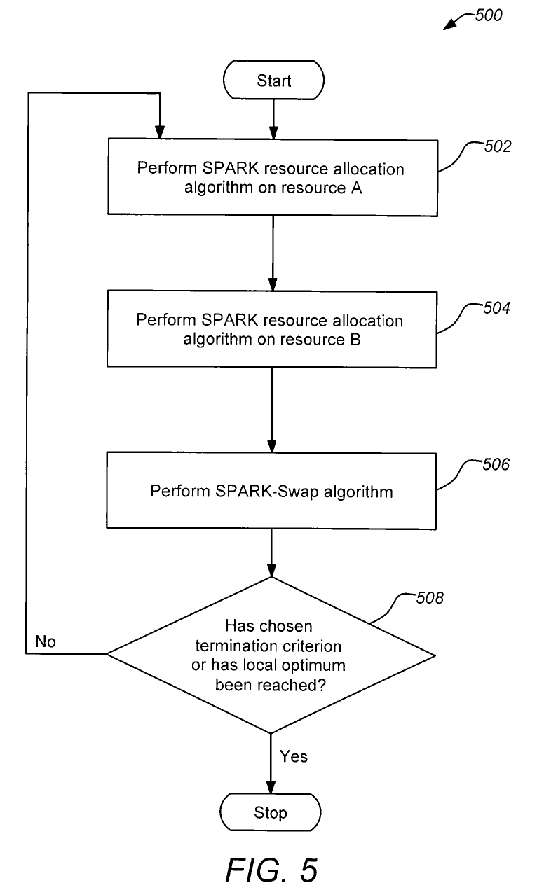

FIG. 5 displays a flowchart 500 for an overview for an exemplary implementation of the invention. First, the SPARK resource allocation algorithm is performed on one of the resources, in this case, resource A in operation 502. Then, the SPARK resource allocation algorithm is performed again, but this time on the other resource, in this case, resource B in operation 504. Next, the SPARK-Swap algorithm is performed in operation 506. Finally, the algorithm checks to see if either the termination criterion or local optimum has been reached in operation 508. If so, the algorithm is complete; if not, the process repeats at operation 502.

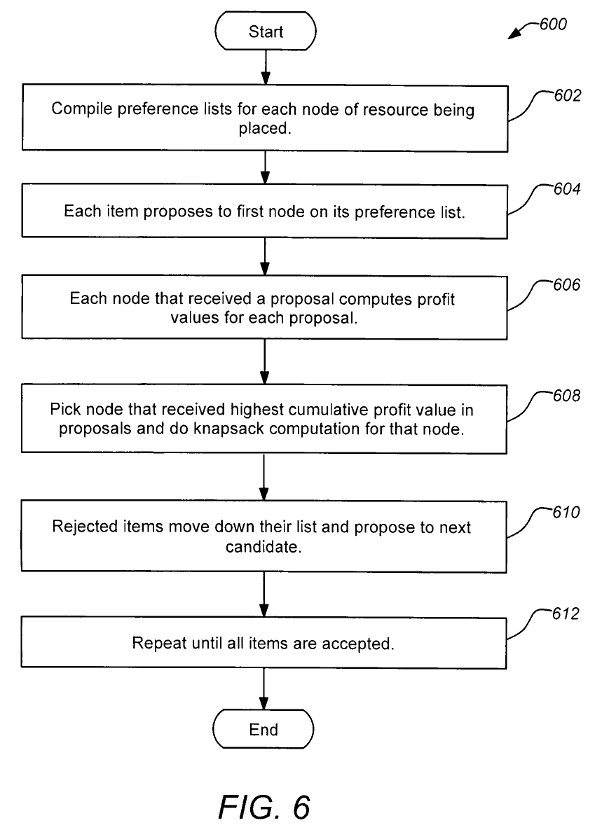

FIG. 6 is a flowchart 600 for a detailed description of an exemplary implementation of the SPARK resource allocation algorithm, which is also steps 502 and 504 in FIG. 5. First, preference lists for each node of the resource being placed is compiled in operation 602. Then, each item proposes to the first node on its preference list in operation 604. Next, each node that received a proposal computes the profit values for each proposal in operation 606. Then, the node that received the highest cumulative profit value in proposals is picked, and a knapsack computation is performed for that node in operation 608. The rejected items move down their list and propose to the next candidate 610. These steps are repeated until all items are accepted in operation 612.

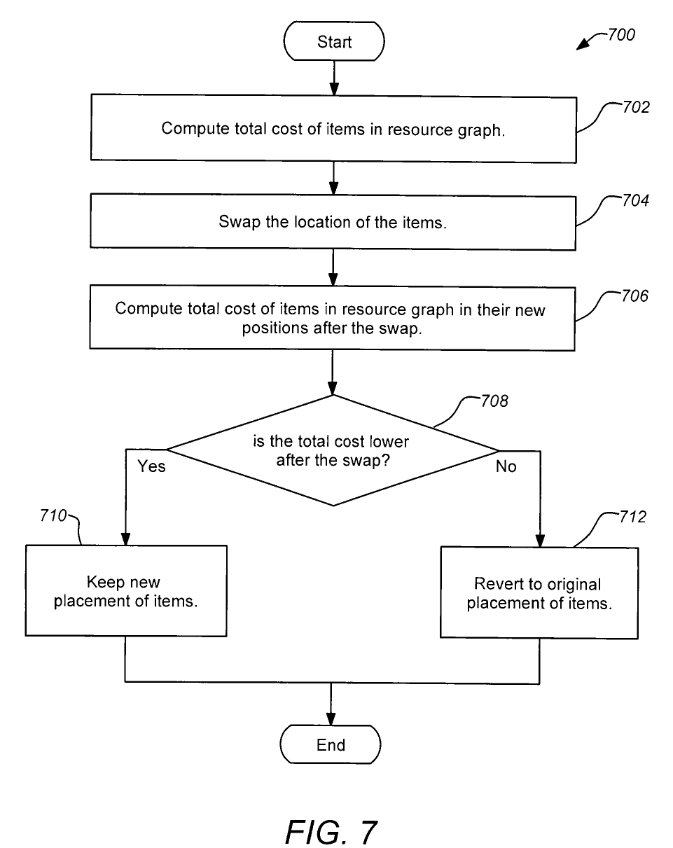

FIG. 7 displays a flowchart 700 for a detailed description of an exemplary implementation of the SPARK-Swap algorithm, which is also step 506 in FIG. 5. First, the total cost of items in the resource graph is computed in operation 702. Then, the items swap location in operation 704. The total cost of items is then computed again in operation 706. The algorithm checks to see if the total cost is lower after the swap in operation 708. If it is, then the new placement of items is kept in operation 710. If not, the resource graph reverts to the original placement of items, before the swap in operation 712.

Performance of an example SPARK algorithm may be evaluated for varying size of the graphs and items. The results may also be compared with other candidate algorithms and Linear Programming (LP) based optimal solutions.

To evaluate the example SPARK algorithm, graphs of varying sizes and number may be simulated of items with different resource requirements and rates. All these parameters are encapsulated into a single metric called Problem Size which is equal to the product of number of items, number of resource-A nodes and number of resource-B nodes. It roughly represents the complexity of the problem.

The different algorithms may compared implemented in C++ and run on a Windows XP Pro machine with Pentium (M) 1.8 GHz processor and 512 MB RAM. For experiments involving time, results can be averaged over multiple runs. The compared algorithms are as follows.

Individual Greedy Placement (INDV-GR): The greedy algorithm that independently places resources independently as shown in Alg-1.

Pairwise Greedy Placement (PAIR-GR): The greedy algorithm that places items into best available resource-A, resource-B pairs—Alg-2.

OPT-LP: The optimal solution obtained by the LP formulation. We used CPLEX Student for obtaining integer solutions (it worked only for the smallest problem size) and popular MINOS solver (through NEOS web service) for fractional solutions in the [0,1] range for other sizes. We could only test up to small size of the graphs (problem size=1.1 M) as the number of variables grew past the limits of the solvers after that.

SPARK: An exemplary embodiment of the SPARK algorithm described in the application.

SPARK-R1: The solution obtained after only a single round of SPARK. This helps illustrate the iteratively improving nature of SPARK.

The size of the graph is shown increased with increasing number of items in the workload. The problem size varied from 140 to 575 M representing a small 10 items workload increasing up to 2500. The quality of the optimization and solution processing time were measured for all implementations. The following example cost function was used.

Cost(Iᵢ,νⱼ,νₖ)=Rate(Iᵢ)*dist(νⱼ,νₖ)

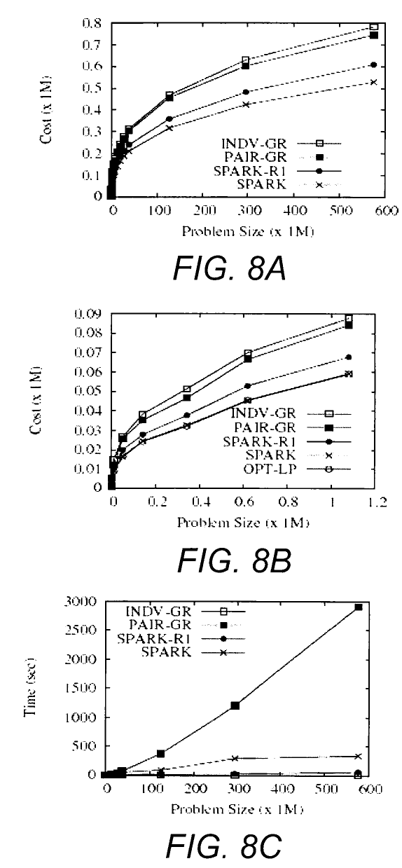

FIG. 8A shows the quality of optimization for INDV-GR, PAIR-GR, SPARK, SPARK-R1. Since OPT-LP only works up to a problem size of 1.1 M (as the number of variables in the LP formulation go past the limits of the solvers), we show a zoomed graph for small sizes in FIG. 8B.

First, notice the separation between the greedy algorithms and SPARK in FIG. 8A. Of the two greedy algorithms, PAIR-GR does better as it places items based on resource-A, resource-B pair distances, whereas INDV-GR's independent decisions do not capture that. It is interesting to see that SPARK-R1 performs better than both greedy algorithms. This is because of using knapsacks (thus picking the right item combinations to place on resources) and placing resource-B based on the corresponding resource-A placement. With every subsequent round, SPARK iteratively improves to the best value shown.

FIG. 8B shows the quality of all algorithms including OPT-LP for small problem sizes. While rest of the trends are similar, it is most interesting to see the closeness in curves of OPT-LP and SPARK. This validates excellent optimization quality of SPARK.

FIG. 8C shows the time taken by implementations in giving a solution. As expected, INDV-GR is extremely fast since it independently places item resource A and B, thus complexity of |Items|*(|A|+|B|). On the other hand, PAIR-GR first generates all resource-A, resource-B pairs and places applications on pairs giving it a complexity of |Items|*|A|*|B|. Each SPARK round would place resource-A and resource-B independently. SPARK-R1 curve shows the time for the first round which is very small. The total processing time in SPARK would be based on the total number of rounds and complexity of the knapsacks in each round. As shown in the graph, it is extremely competitive, taking only 333 seconds even for the largest size of the problem (575 M). Because of its iterative nature and reasonable quality of SPARK-R1, SPARK can actually be prematurely terminated if a quicker decision is required and thus still provide a better solution than comparable algorithms.

This concludes the description including the preferred embodiments of the present invention. The foregoing description including the preferred embodiment of the invention has been presented for the purposes of illustration and description. It is not intended to be exhaustive or to limit the invention to the precise forms disclosed. Many modifications and variations are possible within the scope of the foregoing teachings. Additional variations of the present invention may be devised without departing from the inventive concept as set forth in the following claims.

What is claimed is:

1. A computer program embodied on a computer readable medium, comprising:
program instructions for ranking a first resource node group for each first element of a plurality of coupled items, each of the plurality of coupled items having a first element and a second element;
program instructions for determining placement of each first element of the plurality of coupled items on one first resource node of the first resource node group by iteratively comparing in order of ranking a first profit value associated with each placement and placing the first element having a highest first profit value;
program instructions for ranking a second resource node group for each second element of the plurality of coupled items; and
program instructions for determining placement of each second element of the plurality of coupled items on one second resource node of the second resource node group by iteratively comparing in order of ranking a second profit value associated with each placement and placing the second element having a highest second profit value;
wherein each of the first element and the second element are to be placed on a connected pair of first and second resource nodes and the first profit value and the second profit value are based on a relationship between the connected pair of first and second resource nodes.

2. The computer program of claim 1, wherein the first profit value is determined from a first cost function and the second profit value is determined from a second cost function and the first cost function and the second cost function are each based on a distance value between the connected pair of first and second resource nodes.

3. The computer program of claim 1, further comprising program instructions for knapsack placement of more than one first element of the plurality of coupled items on at least one first resource node of the first resource node group.

4. The computer program of claim 3, further comprising program instructions for swapping placement of a pair of coupled items of the plurality of coupled items and keeping the change only if a lower cost to the resource graph results.

5. The computer program of claim 3, wherein each knapsack placement comprises maximizing a profit value while staying under a specified overall size.

6. The computer program of claim 5, wherein the profit value is determined by a cost difference between two different coupled item placements.

7. The computer program of claim 1, wherein each iteration comprises placement for every first element of each of the plurality of coupled items, followed by placement for every second element of each of the plurality of coupled items.

8. The computer program of claim 7, wherein each iteration further comprises a swap process comprising swapping the placement of a pair of coupled items of the plurality of coupled items, and keeping the change only if a lower cost to the resource graph results or else returning the pair of coupled items to the placement before the swap.

9. The computer program of claim 8, wherein the swap process is performed following placement for every second element of each of the plurality of coupled items.

10. The computer program of claim 8, wherein the iteration is repeated until a chosen termination criterion is met.

11. A method, comprising the steps of:
ranking a first resource node group for each first element of a plurality of coupled items, each of the plurality of coupled items having a first element and a second element;
determining placement of each first element of the plurality of coupled items on one first resource node of the first resource node group by iteratively comparing in order of ranking a first profit value associated with each placement and placing the first element having a highest first profit value;
ranking a second resource node group for each second element of the plurality of coupled items; and
determining placement of each second element of the plurality of coupled items on one second resource node of the second resource node group by iteratively comparing in order of ranking a second profit value associated with each placement and placing the second element having a highest second profit value;
wherein each of the first element and the second element are to be placed on a connected pair of first and second resource nodes and the first profit value and the second profit value are based on a relationship between the connected pair of first and second resource nodes.

12. The method of claim 11, wherein the first profit value is determined from a first cost function and the second profit value is determined from a second cost function and the first cost function and the second cost function are each based on a distance value between the connected pair of first and second resource nodes.

13. The method of claim 11, further comprising the step of knapsack placement of more than one first element of the plurality of coupled items on at least one first resource node of the first resource node group.

14. The method of claim 13, further comprising the step of swapping placement of a pair of coupled items of the plurality of coupled items and keeping the change only if a lower cost to the resource graph results.

15. The method of claim 13, wherein each knapsack placement comprises maximizing a profit value while staying under a specified overall size.

16. The method of claim 15, wherein the profit value is determined by a cost difference between two different coupled item placements.

17. The method of claim 11, wherein each iteration comprises placement for every first element of each of the plurality of coupled items, followed by placement for every second element of each of the plurality of coupled items.

18. The method of claim 17, wherein each iteration further comprises a swap process comprising swapping the placement of a pair of coupled items of the plurality of coupled items, and keeping the change only if a lower cost to the resource graph results or else returning the pair of coupled items to the placement before the swap.

19. The method of claim 18, wherein the swap process is performed following placement for every second element of each of the plurality of coupled items.

20. The method of claim 18, wherein the iteration is repeated until a chosen termination criterion is met.
